(19) United States
(12) Patent Application Publication
(10) Pub. No.: US 2004/0027379 A1
(43) Pub. Date: Feb. 12, 2004

(54) Integrated visual development system for creating computer-implemented dialog scripts

(76) Inventors: Anna OnOn Hong Huey, Fremont, CA (US); Kuok Tou Ho, Campbell, CA (US); Grace L. Hays, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/215,980

(22) Filed: Aug. 8, 2002

(51) Int. Cl. G09G 5/00

(52) U.S. Cl. 345/764

(57) ABSTRACT

A computer-implemented method for visually representing a plurality of components having different data types in a software development environment. The software development environment is configured to develop software that renders the plurality of components during execution of the software. The computer-implemented method includes obtaining a plurality of visual representations, each of the visual representations being associated with a respective one of the plurality of components. Each of the plurality of visual representations being visually indicative of at least one of a content and a format of the respective one of the plurality of components. The computer-implemented method also includes displaying simultaneously the plurality of visual representations in a single panel in the software development environment, the plurality of visual representations being displayed in accordance with a given sequence. The given sequence represents a sequence with which the plurality of components are rendered during the execution.

Interactive transactions between humans and computers are common nowadays. The ubiquitous automatic teller machine (ATM), the Internet browser, the automated telephone transaction system are but a few examples of human-computer interactive transaction systems. In a typical interactive transaction between a human user and an automated telephone transaction system, for example, there is typically a script that is executed by the computer to facilitate interaction with the user in order to accomplish the desired transaction. For example, the script may include dialog segments for greeting the user, for prompting the user to enter any required information, for obtaining data from a back-end database system responsive to the user input and furnishing data to the user, and the like. The dialog segments themselves may include a variety of data contents and data types. With respect to the automated telephone transaction system example, a single dialog segment in the script may need to accommodate static and dynamic data, static and dynamic variables to handle various types of data inputted, audio files, and the like

To facilitate discussion, FIG. 1 depicts exemplary dialog segments of a simple automated travel reservation system. In this example, the user employs the keypad on a telephone to dial up and access the automated travel reservation system and to enter the itinerary number upon gaining access in order to hear information pertaining to the user's travel plan. Thus, after the user is connected with the automated travel reservation system, the system may employ a dynamic audio file to play the first dialog segment 102 to greet the user. In a dialog segment 104, a static text-to-speech file may be executed to ask the user to enter the itinerary number, and a dynamic variable may be employed to store the user's input. To perform error-checking on the user's input, a dynamic grammar file may be employed during the execution of dialog segment 104.

Assuming that the user entered a valid itinerary number, another static text-to-speech file may be executed in dialog segment 106 to inform the user that the system is working to retrieve the information requested. In dialog segment 108, the information retrieved is furnished to the user using a combination of dynamic and static contents.

Although the example of FIG 1 is quite simple, the script in a real-world interactive transaction system may be quite complex. To develop these scripts, developers spend countless hours in a development environment manipulating and assembling abstract data contents into dialog segments to be rendered during execution. In the typical case, the development environment is visually-based, such as on a computer display screen, with the developer writing codes to manipulate and assemble abstract data contents to create each dialog segment. The developer would then execute the codes to test a resultant dialog segment which, like dialog segment 108 in the example of FIG. 1, may comprise different data contents.

If the developer is particularly skilled at mentally visualizing the resultant dialog segment during the development phase, the developer may be able to write codes which, when executed, would render a dialog segment that is fairly close to the desired result. This is however difficult to do since the development environment, being visually based and configured to deal with abstract file names and variables and coding syntax, presents an entirely different experience to the human developer than that experienced by the user when conducting a transaction. That is, the lines of code on the computer display screen of the development environment often results, in the first few tries, in a less than satisfactory rendition of the desired dialog segment. Testing and debugging would eventually result in an acceptable result but both require time and effort, oftentimes a substantial amount of time, effort, and are also tedious.

Some development environments provide a graphical user interface to simplify the dialog segment creation and editing tasks. Generally speaking, these graphical user interfaces implement different templates to allow the developer to enter or edit different dialog components and/or data types of a dialog segment. While the prior art graphical user interfaces are somewhat useful, many developers still find them less than fully integrated, particularly with the use of disjointed templates to edit different components and different data types in a single dialog segment. Many developers regard these prior art graphical user interfaces as being quite cumbersome for use in viewing, creating, and/or editing the dialog segments of a script. Consequently, developers are always looking for ways to improve the development environment and particularly for ways to ease the task of creating satisfactory dialog segments from different abstract data contents and data types so that dialog segments of a script can be developed with less time and effort.

### SUMMARY OF THE INVENTION

The invention relates, in one embodiment, to a computer-implemented method for visually representing a plurality of components having different data types in a software development environment. The software development environment is configured to develop software that renders the plurality of components during execution of the software. The computer-implemented method includes obtaining a plurality of visual representations, each of the visual representations being associated with a respective one of the plurality of components. Each of the plurality of visual representations being visually indicative of at least one of a content and a format of the respective one of the plurality of components. The computer-implemented method also includes displaying simultaneously the plurality of visual representations in a single panel in the software development environment, the plurality of visual representations being displayed in accordance with a given sequence. The given sequence represents a sequence with which the plurality of components are rendered during the execution.

The invention relates, in another embodiment, to a visual development system for creating a computer-implemented script that includes a plurality of dialog segments. The computer-implemented script is configured for use in a computerized interactive transaction system. The visual development system includes a first panel for displaying, at development time of the script, properties associated with a selected one of the plurality of dialog segments. The selected one of the plurality of dialog segments includes at least a first component and a second component configured to be rendered during execution of the computer-implemented script. The first component has a first data type different from a second data type associated with the second component. The first component is visually represented by a first visual representation in the first panel. The second component is visually represented by a second visual representation in the second panel, wherein the first visual representation and the second visual representation are simultaneously displayed in the first panel in accordance with a given sequence. The given sequence represents a sequence with which the first component and the second component are rendered during the execution.

In another embodiment, the invention relates to an article of manufacture comprising a program storage medium having computer readable code embodied therein. The computer readable code is configured for visually representing a plurality of components having different data types in a software development environment. The software development environment is configured to develop software that renders the plurality of components during execution of the software. The article of manufacture includes computer readable code for obtaining a plurality of visual representations, each of the visual representations being associated with a respective one of the plurality of components. Each of the plurality of visual representations is visually indicative of at least one of a content and a format of the respective one of the plurality of components. There is further included computer readable code for displaying simultaneously the plurality of visual representations in a single panel in the software development environment, the plurality of visual representations being displayed in accordance with a given sequence. The given sequence represents a sequence with which the plurality of components are rendered during the execution.

In yet another embodiment, the invention relates to a software product implementing a software development system. The software development system is configured for creating a computer-implemented script that includes a plurality of dialog segments. The computer-implemented script is configured for use in a computerized interactive transaction system. The software development system includes a first panel for displaying, at development time of the script, properties associated with a selected one of the plurality of dialog segments. The properties include at least a dynamic data sample and non-dynamic data. The dynamic data sample represents a sample of dynamic data presented in connection with the selected one of the plurality of dialog segments during execution of the computer-implemented script. The dynamic data sample is visually represented in the first panel by a first visual representation that represents, in a visual manner, an example of the dynamic data presented in connection with the selected one of the plurality of dialog segments during the execution. The non-dynamic data is visually represented in the first panel by a second visual representation that reflects at least one of a content and a format of the non-dynamic data, wherein the first visual representation and the second visual representation are simultaneously displayed in the first panel in accordance with a given sequence. The given sequence represents a sequence with which the dynamic data and the non-dynamic data are rendered during the execution.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts exemplary dialog segments of a simple automated travel reservation system, representing a type of computerized interactive transaction system.

FIG. 2 depicts, in accordance with one embodiment of the present invention, a visual development environment for developing dialog segments of an interactive script.

FIG. 3 depicts, in accordance with one embodiment of the present invention, the visual development environment with another element selected and the properties therefor displayed.

FIG. 4 depicts, in accordance with one embodiment of the present invention, the visual development environment with a different element selected and the properties therefor displayed.

FIG. 5 depicts, in accordance with one embodiment of the present invention, a block diagram showing the development and deployment environment for creating and executing scripts that contain dynamic content.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In accordance with one embodiment of the present invention, there is provided a visual development system for creating scripts for use in a computerized interactive transaction system. The visual development system is configured to allow the developer to create on a computer display screen dialog segments in which dynamic data can be easily added and edited in context relative to other components of the dialog segment. Furthermore, the dynamic data is visually represented to the developer at development time by a dynamic data sample so that the developer can more easily visualize in context the end result.

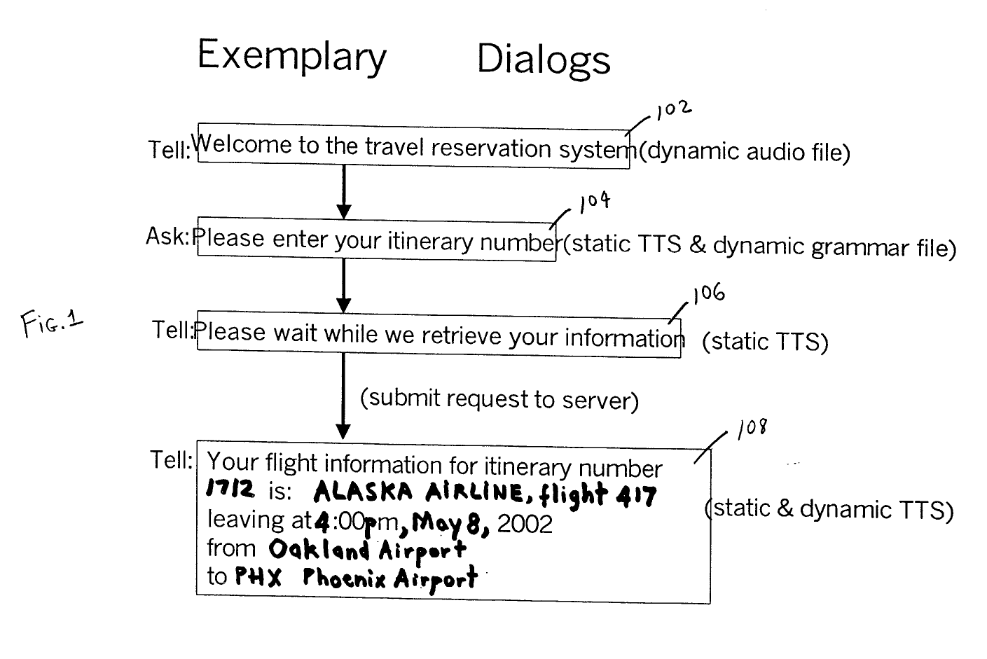

As the term is employed herein, dynamic data represents information that is generated during execution. With reference to the automated travel reservation system example of FIG. 1, dynamic data refers to, for example, the flight information, including the flight number, the departure time, the origin and destination airports. This content is said to be data because the data itself is generated during execution, and different users or itineraries will generate different dynamic data (e.g., different flight information). As such, it is almost impossible to know exactly during development time what the dynamic data will be at execution time.

It is realized by the inventors herein that for the purpose of developing dialog segments, it is not critical that the developer be furnished with the exact dynamic content during development time. In fact, it may be impossible to do so since the dynamic content may depend on other user interactions during execution. However, a dynamic data sample, even though such sample may be different from the actual dynamic data generated during execution, would still greatly help the developer if such is presented in context with other components of the dialog segment an/or is presented in such a way that suggests to the developer at development time how the rendered dynamic data may be like during execution. This is particularly true if the dynamic data sample is analogous to the actual dynamic data rendered during execution. As the term is employed herein, the dynamic data sample may be considered analogous if it is show at development time in a way that suggests to the developer the format, content, and/or location of the actual dynamic data. The dynamic data sample may be considered analogous even if it is rendered in a different medium (e.g., visual) than the medium through which the actual dynamic data is rendered during execution (e.g., audible).

The presentation of the dynamic data sample in context relative to other components of the dialog segment also allows the developer to more accurately visualize at development time the dynamic content in the context of the entire dialog segment. By helping the developer visualize or imagine more accurately how the dynamic content may be rendered in context relative to other components of the dialog segment, the inventive visual development system helps the developer create a more accurate dialog segment on the first try or first few tries, thereby substantially reducing the development cycle.

The dynamic data may be created, in one embodiment, by a drag-and-drop paradigm. That is, no coding is required to create dynamic content in a dialog segment. This feature is particularly useful when the dynamic content is complex. As such, the visual development system is substantially easier to use for developers, a fact greatly appreciated by those developers who have to spend a great deal of time creating countless dialog segments to cover the various possible scenarios of a complex computerized interactive transaction system.

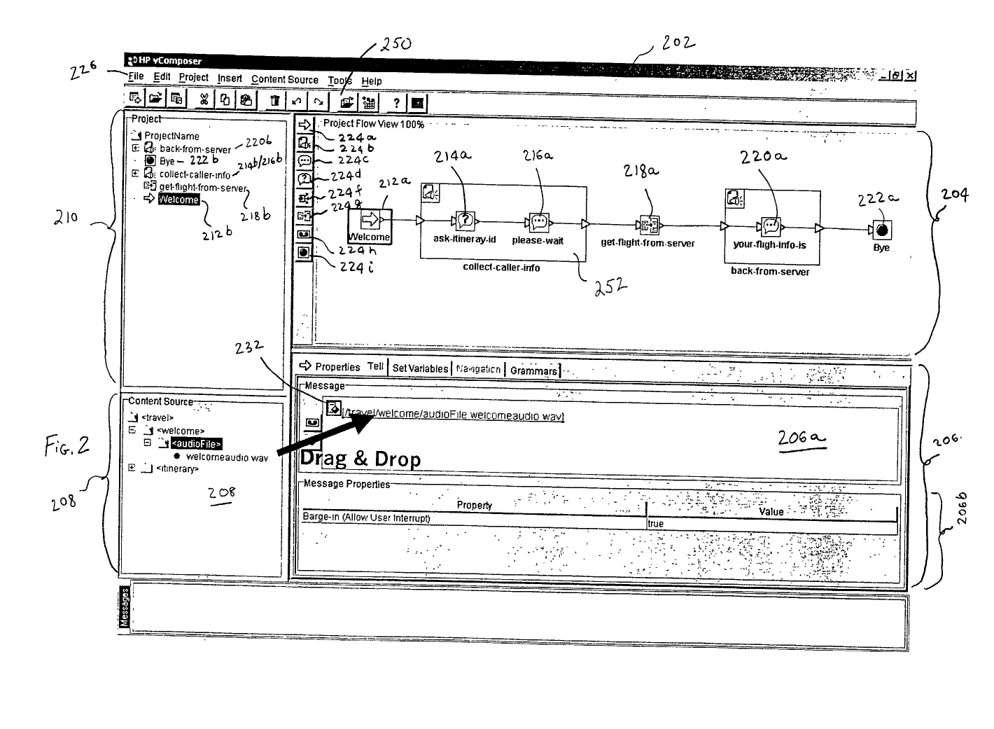

The features and advantages of the present invention may be better understood with reference to the figures and discussions that follow. FIG. 2 depicts, in accordance with one embodiment of the present invention, a visual development environment for developing dialog segments of an interactive script. To facilitate discussion, the automated travel reservation system example is again employed in FIG. 2 although it should be understood that the invention is neither limited to this specific type of interactive application nor to the telephone as the client device. In fact, the invention is suitable for developing any interactive script to be rendered on any type of client device, including those based on the audible, visual, or tactile sense (e.g., browser or non-browser computer display screens, telephones, or even Braille output devices).

Within window 202, there are shown four main panels: a project flow panel 204, a properties panel 206, a content source panel 208, and a project tree panel 210. Project flow panel 204 represents the panel for creating, displaying, and selecting the dialog segments for editing. With reference to FIG. 2, there are shown six dialog elements 212a, 214a, 216a, 218a, 220a, and 222a in project flow panel 204. As can be seen in FIG. 2, these six dialog elements are laid out sequentially. However, they may be laid out differently in other scripts (e.g., including conditional branching and looping) as desired. Also, the six dialog elements shown are only illustrative; there are typically a large number of different types of elements in a real world interactive script.

Another view of the dialog elements for these six dialog elements may be seen in project tree panel 210 in respective elements 212b, 214b, 216b, 218b, 220b, and 222b. The project view furnishes another way to navigate/select dialog elements and can also provide a mechanism to visualize dialog element relationships (e.g. scope). An element may be created by dragging one of icons 224(a-i) into project flow panel 204. Each of icons 224(a-i) represents a different type of element, and each type of element is associated with a different set of properties. For example, icon 224a may represent a start icon, icon 224b may represent a dialog icon, icon 224c may represent a tell icon, icon 224d may represent an ask icon, icon 224f may represent a decision icon, icon 224g may represent a submit-data-to-backend icon, icon 224h may represent a record icon, and icon 224i may represent an exit icon.

Once one of icons 224(a-i) is dragged-and-dropped into project flow panel 204, it serves as a place holder for an element. The new element can also be seen in the project tree panel 210. At this point, default properties may be assigned to the newly created element. To endow the newly created element with customized properties (which includes content) and develop the element into a dialog segment, its associated properties may be modified in properties panel 206 (which is discussed later herein). After the properties of an element are modified, the changes will be saved into a project file by using, for example, the Save Project Command under the File Command 226.

Properties panel 206 represent the panel for viewing and editing properties of the element selected in project flow panel 204. In the example of FIG. 2, the element “Welcome”212a is selected. Accordingly, its corresponding element 212b is highlighted in project panel 210 of FIG. 2. Further, properties panel 206 show the properties associated with this selected element 212a.

With respect to Content Source panel 208, a sample XML file can be selected and displayed in the Content Source panel 208 by clicking on the Content Source Command icon (250). After Content Source Command icon (250) is selected, the user may select from a menu the name of the sample XML file to be displayed in the Content Source panel 208. In the case of element 212a, which represents a dialog segment for rendering a dynamic audio file, properties panel 206 include two main sub-panels: a message sub-panel 206a and a message properties sub-panel 206b. Message sub-panel 206a shows the developer the content of the selected element 212a, wherein message properties sub-panel 206b shows the developer the properties associated with the content. In the context of the present example, message sub-panel 206a shows that the content of the selected element “Welcome” is dynamic content, and more specifically is a dynamic audio file that can be found at the relative location “/travel/welcome/audioFile.” Furthermore, message sub-panel 206a shows that the dynamic audio file sample is an XML sample named “welcomeaudio.wav.” In message properties sub-panel 206b, the developer is shown that the dynamic audio file rendered during execution has the property of being capable of being interrupted by the user. The properties of the selected element 212a may of course be modified as desired within message properties sub-panel 206b.

In accordance with one embodiment of the present invention, the properties shown in message sub-panel 206a are created automatically by the visual development system when the developer drags-and-drops the XML sample “welcomeaudio.wav” from content source panel 208 into message sub-panel 206a. The icon 232, with its unique look, shows that the message shown between the square brackets that follow includes the location indicator and the sample of the dynamic content. To elaborate, the first part of the properties representation (i.e., “/travel/welcome/audioFile”) is created from the content source tree hierarchy, as can be seen from content source panel 208. This first part indicates the relative location where the dynamic content may be found within the XML file. The second part of the properties representation (i.e., “welcomeaudio.wav”) is the XML sample that was dropped into message subpanel 206a. As such, the visual development system furnishes a non-programming way for developers to create the content of the selected element, to view a sample of the dynamic content in context with other components of the selected element, as well as to specify the properties for the selected element (by selecting the message properties in message properties sub-panel 206b). Other property panels for other dialog elements offer additional mechanisms (e.g. explicit editing capabilities) to specify element properties.

In accordance with one embodiment of the present invention, the dynamic data from the back-end database is stored in the XML format. That is, the visual development system expects to receive dynamic data in the XML format. An XML sample of the dynamic data is available to the developer at development time to enable the developer to insert the dynamic content into the dialog segment and to visually represent to the developer the dynamic content in context with other components of the dialog segment.

By looking at the window of FIG. 2, the developer can tell which element (e.g., 212a) is currently the focus (based on which element is highlighted in project flow panel 204), the message associated with the selected element (based on the information in message panel 206a), properties associated with the message (based on the information in properties panel 206b), including the location and sample of the dynamic data.

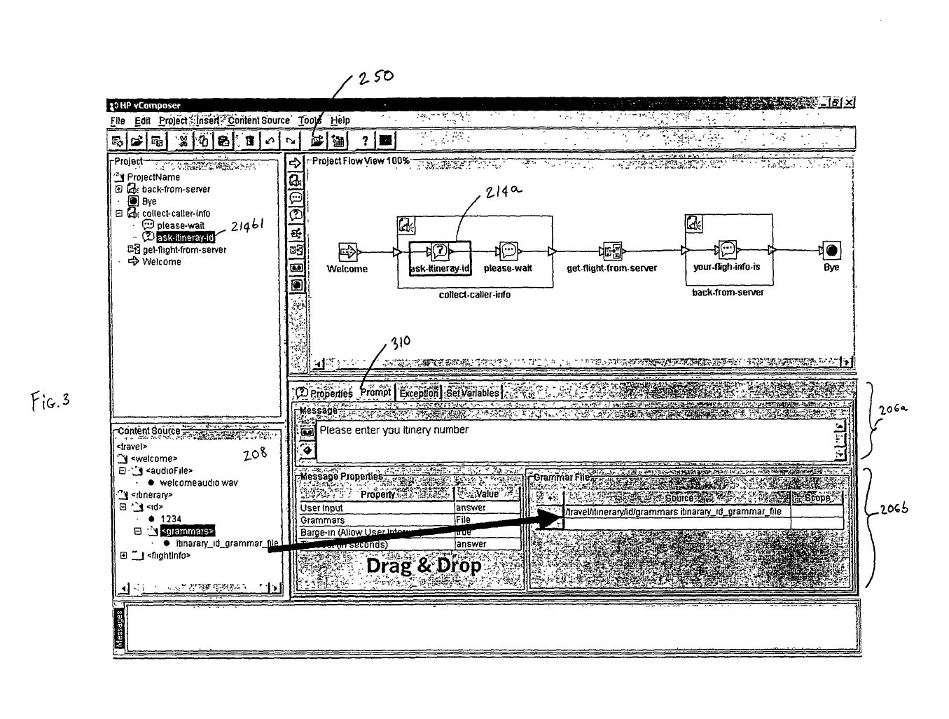

In FIG. 3, the sub-element “ask-itinerary-id” 214a is the selected element. Accordingly, its corresponding element in the project tree panel (214b) is highlighted in project panel 210 of FIG. 3. The static text-to-speech portion of this selected element may be created by the developer when the developer selects the “Prompt” tab 310 and types into message sub-panel 206a the phrase “Please enter your itinerary number.”

Message properties sub-panel 206b of FIG. 3 shows the various properties associated with the content of selected element 214a. As shown in message properties sub-panel 206b of FIG. 3, the user input is shown to be held in a variable “answer,” and the grammar for the user input is shown to be governed by a file. User interruption (barge-in) is allowed and the time-out value for this user input operation is shown to be 10 seconds.

In the example of FIG. 3, the grammar file that governs the grammar of the user input is dynamic. To clarify, the grammar associated with an input specifies the expectation for the input, which may include the format of the input data, the range of the input data, the data types of the input data, and the like. The developer may create this dynamic content by dragging-and-dropping the dynamic grammar file from content source panel 208 into grammar file sub-panel 240. Alternatively or additionally, the developer may create the dynamic content for the grammar by dragging and dropping

The first part of the dynamic grammar file representation (i.e., “/travel/itinerary/grammars”) is created from the content source tree hierarchy, as can be seen from content source panel 208. This first part of the dynamic grammar file representation indicates the relative location where the dynamic grammar file may be found within the XML file. The second part of the dynamic grammar file representation (i.e., “itinerary_id_grammar_file”) is the XML sample of the dynamic grammar file that was dropped into message sub-panel 206a.

By looking at the window of FIG. 3, the developer can tell that the askitinerary-id (214a) is currently the focus (based on which element (e.g., 214a) is highlighted in project flow panel 204), the message associated with the selected element (based on the information in message panel 206a), properties associated with the message (based on the information in properties panel 206b), including the location and sample of the dynamic data.

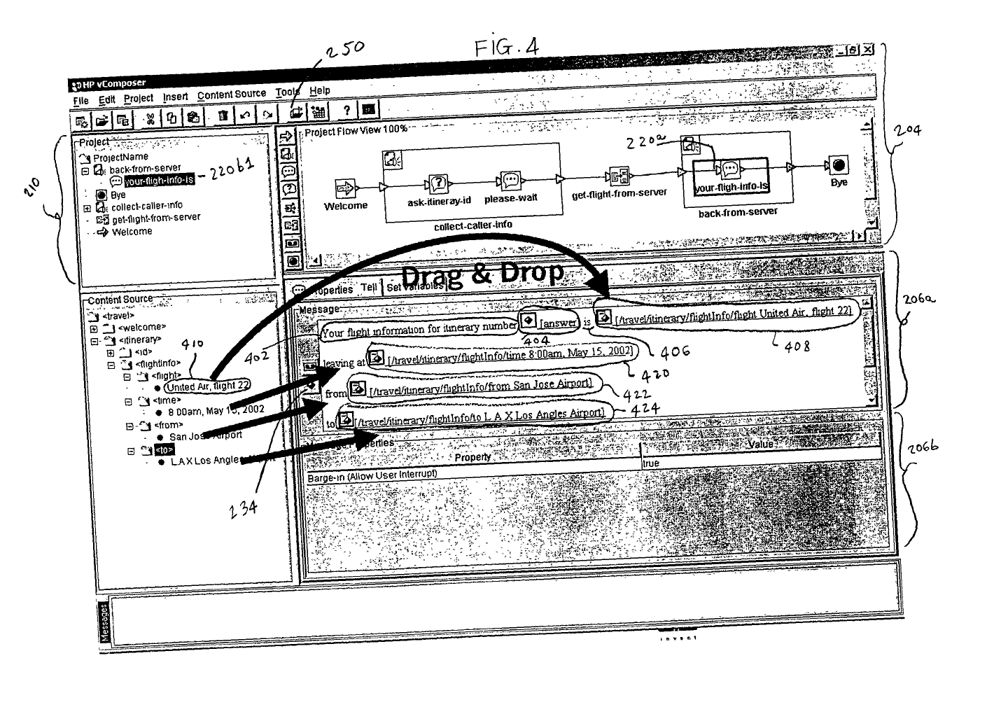

In FIG. 4, the “your flight info is” element 220a is the selected element. Accordingly, its corresponding element 220b1 is highlighted in project panel 210 of FIG. 4. FIG. 4 is useful in illustrating how the invention allows the developer to weave many different content types in a single dialog segment yet be able to retain the ability to visualize various components, including dynamic content, in context. Starting with the first data type, the static text-to-speech portion 402 of this selected element may be created by the developer when the developer types into message sub-panel 206a the phrase “Your flight information for itinerary number.”

The itinerary number was entered previously by the user and its value was held in the dynamic variable “answer” as discussed earlier in FIG. 2. Thus, the next component of the dialog segment is the value of the dynamic variable “answer.” With reference to FIG. 3, the developer may insert the value of this dynamic variable “answer” into the dialog segment by 1) inserting a space holder into the dialog segment by dragging-and-dropping a variable icon 234 into message sub-panel 206a at the desired location (e.g., after the static text-to-speech portion 402), and 2) clicks on the variable icon recently dropped into message sub-panel 206a to cause of list of available variables to be displayed from which the developer may select the desired variable. The result is shown by reference number 404.

The next component of the dialog segment is a short static text-to-speech word “is” as shown by reference number 406. After the static text-to-speech word “is” (406), the next component is the dynamic content for rendering the airline and flight number (see discussion in box 108 of FIG. 1). This portion is indicated in FIG. 4 by reference number 408. The developer may create this dynamic content by dragging and dropping the XML sample “United Air, flight 22” (410) from content source panel 208 into message sub-panel 206a. As before, the first part of the dynamic data representation (i.e., “/travel/itinerary/flightinfo/flight”) is created from the content source tree hierarchy, as can be seen from content source panel 208, and indicates the location where the dynamic data may be found. The second part of the dynamic data representation (i.e., “United Air, flight 22”) is the sample XML data that is representative of the dynamic data actually generated at execution time. Note that the sample XML data shown in message panel 206a (i.e., “United Air, flight 22”) is only a sample shown at development time for the benefit of the developer. The actual dynamic data generated during execution of course is dynamic in nature and the actual value generated would differ in almost all cases from the XML sample shown (as illustrated in box 108 of FIG. 1).

Also note that the creation of this dynamic content is achieved by a drag-and-drop paradigm, which relieves the developer from having to code dynamic content by hand. By visually presenting this sample XML data in the context of other components of the dialog segment, the developer can better visualize the resultant dialog segment, which helps the developer in the task of developing dialog segments.

Subsequent dynamic contents 420, 422, and 424 of the dialog segment are similarly created. In each case, the dynamic content is created by dragging-and-dropping its corresponding XML sample at the appropriate location in message subpanel 206a. In each case, the developer is able to visually appreciate the sample dynamic content in context relative to other components of the dialog segment. Consequently, even though the dialog segment may comprise multiple components, each of which may be of a different data type, the developer can still easily visualize all components, including samples of dynamic contents, in a single message panel.

The sample XML file inputted by the developer via the visual development system will be applied to VDML data model to be converted into XSL (eXtensible Stylesheet Language) stylesheets by the visual development system. VDML is a customized version of XML, and an XML data model may well be employed instead. In one embodiment, the static data is embedded into the XSL stylesheets themselves. During execution, the actual XML dynamic data will be applied to the XML stylesheets by a XSL stylesheet engine to create dialog segments and grammars.

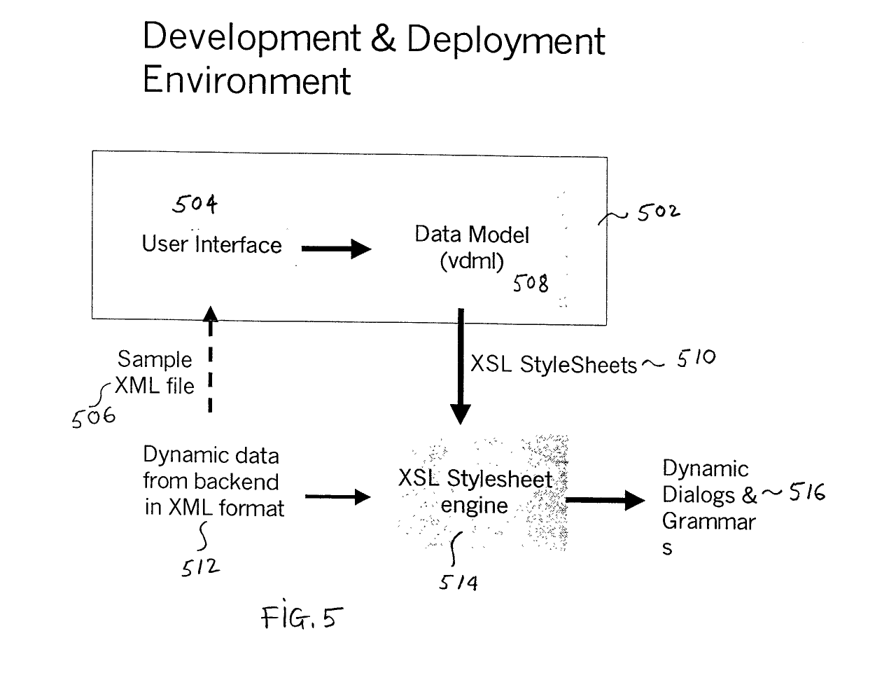

FIG. 5 depicts, in accordance with one embodiment of the present invention, a block diagram showing the development and deployment environment for creating and executing scripts that contain dynamic content. In FIG. 5, there is shown a visual development system 502, representing an implementation of the inventive visual development system discussed herein. A user interface 504 enables the developer to create dialog segments having different data types and to associate properties with the dialog segments created. During development, the sample XML file 506 is employed to represent the dynamic content inputted by the developer into the dialog segments. This aspect has been discussed earlier with reference to FIGS. 1-4 herein. Although only one XML file is shown in FIG. 5, multiple XML files may be employed if desired.

The relative location where the dynamic data may be found within the XML file is stored in the VDML data model 508 to create XSL stylesheets 510. In the context of the present invention, VDML is a customized version of XML, and an XML data model may well be employed. During execution, when an application (such as a Java Server Page, or JSP) requests the dynamic data. The application server will request the actual XML dynamic data file 512 to be furnished by the backend, which is then applied to the corresponding XSL stylesheet(s) 510 by a XSL stylesheet engine 514. XSL stylesheet engine 514, which is typically deployed on the application server, will then produce dynamic dialog segments and grammars(516) in the appropriate mark-up language or medium to be rendered on the target client device (such as HTML for browsers, audio dialogs for the telephone, or the like).

In accordance with one embodiment of the present invention, the speech properties of a text-to-speech component of a dialog segment may be customized by the developer to enhance its rendering. With reference to FIG. 4, for example, the developer may select the text-to-speech component 402, right click to cause an additional pop up menu to appear through which the developer may customize the speech properties of the TTS component. FIG. 6 shows an example of such a speech modifying pop up menu. In pop up menu 602, the selected component is highlighted (604), and the speech properties options are displayed in the pop up menu . 46 In the example of FIG. 6, the developer may select multiple options for the TTS to be rendered, for example with emphasis (606), using a male voice (608), or using a female voice (610). Of course other speech properties (including pitch, range, volume, etc.) may also be provided. FIG. 6 shows that the TTS is to be rendered with the male voice (608) and with emphasis (606) using high pitch prosody. In another embodiment, the speech customization properties may be specified for multiple components (whether or not TTS) or all components of the dialog segment. In this case, the value in the field 620 of FIG. 6 would indicate the type or types for the component whose speech properties are being customized.

In accordance with one embodiment of the present invention, each component of the dialog segment has a visual representation that allows the developer to readily appreciate the content and/or format of that component when that component and other components of a dialog segment is rendered during execution. With reference to FIG. 4, for example, the static text-to-speech (TTS) component 402 is visually represented by the text “Your flight information for itinerary number” in sub-panel 206a. The dynamic variable component 404 for storing the user input pertaining to the itinerary is visually represented by an icon for dynamic data and the variable name in square brackets (“[answer]”), the dynamic content component 408 is represented by the path “/travel/itinerary/flightlnfo/flight” and the XML sample “United Air, flight 22.” Other components are analogously represented visually in sub-panel 206a.

Moreover, the visual representations associated with components of the dialog segment in sub-panel 206a are visually concatenated and sequenced in the order with which they would be rendered during execution. Since the different components, which may be associated with different data types and contents, are all visually represented, their visual representations can be concatenated and presented in the components' expected order for the benefit of the developer. The different types of components available in the preferred embodiment include, but are not limited to the following: static content, dynamic content, variables, and audio files. The developer, when looking at the visually integrated view of sub-panel 206a, can readily envision the rendered dialog segment and can readily appreciate how the dialog segment would likely be rendered when executed at execution time

This level of visual representation of the components and the visual concatenation thereof in the integrated manner implemented by the inventors herein have not been found in the prior art. Moreover, the visual representation of dynamic data in the development environment using its relative path/sample during development time, and the ability to employ such visual representation of dynamic data in the concatenated view are also features not found in the prior art. Additionally, the logical arrangement of the various views also assist the developer in visualizing the script, its dialog segments, the components thereof, and the properties thereof, all in a single integrated window. For example, by viewing the project flow panel (204), the developer can readily appreciate the number of elements as well as the sequence of those elements in the script. By viewing the properties panel 206 and in particular sub-panel 206a therein, the developer can readily view the number of components, the content or sample for each component, and the sequencing of the components in the specific element selected. Furthermore, by viewing sub-panel 206b of properties panel 206, the developer can view additional properties information associated with the dialog segment displayed in sub-panel 206a.

Thus, each of panels 204, 206a, and 206b provides progressively more detailed information, which enables the developer to either focus in on specific properties of a dialog segment, or view the overall project flow of the elements of the entire script. If the developer desires to visually preview how the entire script may be rendered, the developer may simply select the elements in project flow panel 204 in a rapid, sequential manner, and as each element is selected, the content of the dialog segment associated with that segment would be displayed in sub-panel 206a, with additional properties details displayed in sub-panel 206b.

Thus, while this invention has been described in terms of several preferred embodiments, there are alterations, permutations, and equivalents which fall within the scope of this invention. For example, instead of dragging and dropping an item at a target location, the user may click in the target location and be furnished with a selectable list from which the user may chose the desired item. As a further example, although XML is discussed as a preferred format for storing dynamic data and representing dynamic data samples, other similarly suitable markup languages may well be employed.

As yet another example, although the voice or telephone application is discussed herein to facilitate understanding, the invention is not limited to applications utilizing a single mode for input/output. It should be understood that the invention, and particularly the visual concatenation and dynamic data representation aspects thereof, also apply to a multi-modal application in which the input and output may be a combination of different modes (such as voice, visual, tactile, and the like). As such, the dynamic variables, the data model and/or dynamic data storage/sample may be implemented using not only XML but also any appropriate mark-up language such as WML, XHTML, and the like.

It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer-implemented method for visually representing a plurality of components having different data types in a software development environment, said software development environment being configured to develop software that renders said plurality of components during execution of said software, comprising:
obtaining a plurality of visual representations, each of said visual representations being associated with a respective one of said plurality of components, said each of said plurality of visual representations being visually indicative of at least one of a content and a format of said respective one of said plurality of components; and
displaying simultaneously said plurality of visual representations in a single panel in said software development environment, said plurality of visual representations being displayed in accordance with a given sequence, said given sequence representing a sequence with which said plurality of components are rendered during said execution.

2. The computer-implemented method of claim 1 wherein said plurality of components are rendered during said execution using at least one mode different from a visual mode, said one mode includes one of an audible mode and a tactile mode.

3. The computer-implemented method of claim 1 wherein said software represents a software for implementing an automated telephone transaction system, said plurality of components are audibly rendered during said execution.

4. The computer-implemented method of claim 1 wherein said plurality of visual representations are visually concatenated in said single panel.

5. The computer-implemented method of claim 1 wherein at least one of said plurality of components is dynamic data, a visual representation associated with said dynamic data being a sample of said dynamic data and having an analogous format to a format of said dynamic data during said execution.

6. The computer-implemented method of claim 1 wherein at least one of said plurality of components is dynamic data, a visual representation associated with said dynamic data being a sample of said dynamic data and having an analogous content to a content of said dynamic data during said execution.

7. The computer-implemented method of claim 1 wherein at least one of said plurality of components is dynamic data, a visual representation associated with said dynamic data being a sample of said dynamic data, said sample of said dynamic data being stored using a data-describing mark-up language.

8. The computer-implemented method of claim 7 wherein said data-describing mark-up language is one of XML, WML, and XHTML.

9. The computer-implemented method of claim 8 wherein another one of said plurality of components is static data, said visual representation associated with said dynamic data and a visual representation associated with said static data are visually concatenated in said single panel.

10. The computer-implemented method of claim 7 wherein said visual representation associated with said dynamic data is furnished in said single panel via a drag-and-drop operation.

11. A visual development system for creating a computer-implemented script that includes a plurality of dialog segments, said computer-implemented script being configured for use in a computerized interactive transaction system, comprising:
a first panel for displaying, at development time of said script, properties associated with a selected one of said plurality of dialog segments, said selected one of said plurality of dialog segments includes at least a first component and a second component configured to be rendered during execution of said computer-implemented script, said first component having a first data type different from a second data type associated with said second component, said first component being visually represented by a first visual representation in said first panel, said second component being visually represented by a second visual representation in said second panel,
wherein said first visual representation and said second visual representation are simultaneously displayed in said first panel in accordance with a given sequence, said given sequence representing a sequence with which said first component and said second component are rendered during said execution.

12. The visual development system of claim 11 wherein said first data type is dynamic data, said first visual representation being a sample of said dynamic data and having an analogous format to a format of said dynamic data during said execution.

13. The visual development system of claim 11 wherein said first data type is dynamic data, said first visual representation being a sample of said dynamic data and having an analogous content to a content of said dynamic data during said execution.

14. The visual development system of claim 11 wherein said sample is stored using a data-describing mark-up language.

15. The visual development system of claim 14 wherein said data-describing mark-up language is one of XML, WML, and XHTML.

16. The visual development system of claim 11 wherein said first data type is dynamic data and said second data type is one of a static textual data and a static variable.

17. The visual development system of claim 11 further comprising a project flow panel for displaying, at said development time, at least some of said plurality of dialog segments in a dialog segment sequence, said dialog segment sequence representing a sequence with which said some of said plurality of dialog segments are rendered during said execution.

18. The visual development system of claim 11 wherein said computerized interactive transaction system represents an automated telephone transaction system, said first component and said second component are audibly rendered during said execution.

19. The visual development system of claim 11 wherein said first component and said second component are rendered during said execution using at least one mode different from a visual mode.

20. The computer-implemented method of claim 11 wherein said first visual representation and said second visual representation are visually concatenated in said first panel.

21. An article of manufacture comprising a program storage medium having computer readable code embodied therein, said computer readable code being configured for visually representing a plurality of components having different data types in a software development environment, said software development environment being configured to develop software that renders said plurality of components during execution of said software, comprising:
computer readable code for obtaining a plurality of visual representations, each of said visual representations being associated with a respective one of said plurality of components, said each of said plurality of visual representations being visually indicative of at least one of a content and a format of said respective one of said plurality of components; and
computer readable code for displaying simultaneously said plurality of visual representations in a single panel in said software development environment, said plurality of visual representations being displayed in accordance with a given sequence, said given sequence representing a sequence with which said plurality of components are rendered during said execution.

22. The computer readable code of claim 21 wherein said software represents a software for implementing an automated telephone transaction system, said plurality of components are audibly rendered during said execution.

23. The computer readable code of claim 21 wherein said plurality of visual representations are visually concatenated in said single panel.

24. The computer readable code of claim 21 wherein a first component of said plurality of components is dynamic data, a second component of said plurality of components is non-dynamic data.

25. The computer readable code of claim 21 wherein at least one of said plurality of components is dynamic data, a visual representation associated with said dynamic data being a sample of said dynamic data, said sample of said dynamic data being stored using a data-describing mark-up language.

26. The computer readable code of claim 25 wherein said visual representation associated with said dynamic data is furnished in said single panel via a drag-and-drop operation.

27. The computer readable code of claim 25 wherein said data-describing mark-up language is one of XML, WML, and XHTML.

28. The computer readable code of claim 25 wherein another one of said plurality of components is static data, said visual representation associated with said dynamic data and a visual representation associated with said static data are visually concatenated in said single panel.

29. A software product implementing a software development system, said software development system being configured for creating a computer-implemented script that includes a plurality of dialog segments, said computer-implemented script being configured for use in a computerized interactive transaction system, said software development system comprising:
a first panel for displaying, at development time of said script, properties associated with a selected one of said plurality of dialog segments,
said properties including at least a dynamic data sample and non-dynamic data, said dynamic data sample representing a sample of dynamic data presented in connection with said selected one of said plurality of dialog segments during execution of said computer-implemented script, said dynamic data sample being visually represented in said first panel by a first visual representation that represents, in a visual manner, an example of said dynamic data presented in connection with said selected one of said plurality of dialog segments during said execution, said nondynamic data being visually represented in said first panel by a second visual representation that reflects at least one of a content and a format of said non-dynamic data,
wherein said first visual representation and said second visual representation are simultaneously displayed in said first panel in accordance with a given sequence, said given sequence representing a sequence with which said dynamic data and said non-dynamic data are rendered during said execution.

30. The software product of claim 29 wherein said dynamic data presented in connection with said selected one of said plurality of dialog segments during said execution is stored using a data-describing mark-up language.

31. The software product of claim 30 wherein said data-describing mark-up language is one of XML, WML, and XHTML.

32. The software product of claim 31 wherein said data-describing mark-up language is XML.

33. The software product of claim 30 wherein said dynamic data sample is stored using said data-describing mark-up language.

34. The software product of claim 33 wherein said data-describing mark-up language is one of XML, WML, and XHTML.

35. The software product of claim 33 wherein said first visual representation and said second visual representation are visually concatenated in said first panel.

36. The software product of claim 35 wherein said first visual representation and said second visual representations are user-selectable items, properties associated with said dynamic data sample being displayed in a second panel when said first visual representation is selected by a user of said software development system, properties associated with said non-dynamic data sample being displayed in said second panel when said second visual representation is selected by said user of said software development system

37. The software product of claim 29 wherein said non-dynamic data is text-to-speech data (TTS), said software product further comprising a speech-modifying panel configured to modify properties of said text-to-speech data when said second visual representation is selected by a user of said software development system.
